(19) United States
(12) Patent Application Publication
(10) Pub. No.: US 2026/0264112 A1
(43) Pub. Date: Sep. 10, 2026

(54) DYNAMIC FLUIDIZED BED SYSTEM AND DYNAMIC FLUIDIZED SEPARATION METHOD

(71) Applicant: CHINA UNIVERSITY OF MINING AND TECHNOLOGY, Xuzhou (CN)

(72) Inventors: Enhui ZHOU, Xuzhou (CN); Chenlong Duan, Xuzhou (CN); Ruikang Fan, Xuzhou (CN); Liang Dong, Xuzhou (CN); Yifan Wang, Xuzhou (CN); Yu Wang, Xuzhou (CN)

(21) Appl. No.: 19/658,050

(22) Filed: Apr. 24, 2026

(30) Foreign Application Priority Data
Mar. 7, 2025 (CN) 202510270661.4

(51) Int. Cl. B07B 11/04; B07B 4/08; B07B 11/06

(52) U.S. Cl. CPC B07B 11/04; B07B 4/08; B07B 11/06

(57) ABSTRACT

The present disclosure discloses a dynamic fluidized bed system and a dynamic fluidized separation method, belonging to the technical field of measurement technology for separation fluidized particle systems, aiming to solve the problem of poor detection accuracy of the mixing and separation state of pulverized coal during the separation process in the prior art. In the dynamic fluidized bed system of the present disclosure, a pressure acquisition unit collects pressure signals at different vertical positions within the bed layer and transmits them to a controller. The controller receives the pressure signals, calculates differential pressure signals, converts the differential pressure signals into density signals, processes the density signals to generate Hilbert spectrums of particles in the bed layer, and determines whether the bed layer is in a mixed state or a separated state based on the Hilbert spectrums. The present disclosure can be used for dynamic fluidized separation of raw coal.

### CROSS-REFERENCE TO RELATED APPLICATIONS

This application claims priority to Chinese Patent Application No. 202510270661.4, filed on Mar. 7, 2025, which is hereby incorporated by reference in its entireties.

### TECHNICAL FIELD

The present disclosure belongs to the technical field of measurement technology for separation fluidized particle systems, and particularly relates to a dynamic fluidized bed system and a dynamic fluidized separation method.

### BACKGROUND

Gas-solid fluidized separation technology is an important dry coal preparation technology. For fine coal separation, a dynamic fluidized bed system is typically used for gas-solid fluidized separation.

In the actual separation process, pulverized coal with a particle size below 0.5 mm tends to stratify with the heavy medium, affecting the subsequent separation effect. Therefore, detecting the mixing and separation state of pulverized coal below 0.5 mm and the heavy medium is crucial for separation. However, in the prior art, the detection accuracy for the mixing and separation state of pulverized coal below 0.5 mm is poor.

### SUMMARY

In view of the above analysis, the present disclosure aims to provide a dynamic fluidized bed system and a dynamic fluidized separation method to solve the problem of poor detection accuracy of the mixing and separation state of pulverized coal during the separation process in the prior art.

The purpose of the present disclosure is mainly achieved through the following technical solutions.

The present disclosure provides a dynamic fluidized bed system, comprising a blower, a vibrating table, a fluidization chamber, a pressure acquisition unit, and a controller; the fluidization chamber is placed on the vibrating table, the vibrating table drives the fluidization chamber to vibrate, and an air outlet of the blower is connected to an inner cavity of the fluidization chamber; data acquisition ends of the pressure acquisition unit are located in a bed layer of the fluidization chamber, the pressure acquisition unit acquires pressure signals at different vertical positions within the bed layer and transmits them to the controller, the controller receives the pressure signals, calculates differential pressure signals, converts the differential pressure signals into density signals, processes the density signals to generate Hilbert spectrums of particles in the bed layer, and determines whether the bed layer is in a mixed state or a separated state based on the Hilbert spectrum.

Further, the pressure acquisition unit comprises an upper pressure acquisition assembly, a middle pressure acquisition assembly, and a lower pressure acquisition assembly arranged sequentially from top to bottom, the upper pressure acquisition assembly is used to acquire two pressure signals at different vertical positions in the upper part of the bed layer, the middle pressure acquisition assembly is used to acquire two pressure signals at different vertical positions in the middle part of the bed layer, and the lower pressure acquisition assembly is used to acquire two pressure signals at different vertical positions in the lower part of the bed layer.

Further, the upper pressure acquisition assembly, the middle pressure acquisition assembly, and the lower pressure acquisition assembly each comprise two pipes and one pressure sensor, the two pipes are detachably and fixedly connected, the pressure sensor has two data input ports, the pipes correspond one-to-one with the data input ports, the pipes are connected to the data input ports, the pipes are inserted into the bed layer, and the two pipes are located at different vertical positions within the bed layer.

Further, the height difference between the two pipes is 1.5 to 2.5 cm, and the inner diameter of the pipes is 3 to 5 mm.

Further, the upper pressure acquisition assembly, the middle pressure acquisition assembly, and the lower pressure acquisition assembly each further comprise filter layers, and the filter layers are sleeved on air inlets of the pipes.

Further, the dynamic fluidized bed system further comprises a flow regulating valve arranged on a connecting pipeline between an air reservoir and the fluidization chamber.

Further, the dynamic fluidized bed system further comprises a flow meter arranged on the connecting pipeline between the air reservoir and the fluidization chamber.

Further, the dynamic fluidized bed system further comprises an air distribution chamber, an air distribution plate, and an air distribution layer, the air distribution chamber is located at the bottom of the fluidization chamber and is connected to the fluidization chamber, a bottom end of the air distribution chamber is connected to the vibrating table, the air distribution plate and the air distribution layer are arranged between the air distribution chamber and the fluidization chamber, and an air inlet of the air distribution chamber is connected to the air outlet of the blower.

The present disclosure also provides a dynamic fluidized separation method, using the dynamic fluidized bed system described above, the separation method comprising the following steps:
step 1: setting a sampling frequency and sampling time of the pressure acquisition unit, selecting a vibration frequency, a vibration amplitude, a gas supply flow rate, and a coal sample flow rate;
step 2: starting the vibrating table and the blower, feeding coal samples into the fluidization chamber, where the coal samples are samples of raw coal;
step 3: the pressure acquisition unit acquiring pressure signals at different vertical positions within the bed layer and transmitting them to the controller, the controller receiving the pressure signals, calculating differential pressure signals, converting the differential pressure signals into density signals, and processing the density signals to generate Hilbert spectrums of particles in the bed layer;
step 4: determining whether the bed layer is in a mixed state or a separated state based on the Hilbert spectrums;
in case the bed layer is in a mixed state, proceed to step 5;
in case the bed layer is in a separated state, increase the vibration frequency, vibration amplitude, and/or gas supply flow rate, and/or decrease the coal sample flow rate, and repeat step 3;
step 5: feeding raw coal into the fluidization chamber, and separating the raw coal according to the selected vibration frequency, vibration amplitude, gas supply flow rate, and coal sample flow rate.

Further, step 3 comprises the following steps:
step 31: the pressure acquisition unit respectively acquiring two sets of pressure signals from the upper part, two sets from the middle part, and two sets from the lower part of the bed layer, and transmitting them to the controller;
step 32: the controller receiving the pressure signals and calculating a differential pressure signal for the upper part of the bed layer, a differential pressure signal for the middle part of the bed layer, and a differential pressure signal for the lower part of the bed layer;
step 33: converting the differential pressure signals into density signals using a conversion formula, the conversion formula being formed after calibration of the pressure sensor, the conversion formula is as follows:

$$ρ = \frac{Δ P}{gh}$$

where:
ρ is the bed density, g/cm³;
ΔP is the differential pressure signal, Pa;
g is the gravitational coefficient, N/kg;
h is the height difference of the pipes, mm;
step 34: defining the set of all ρ as the density signals, performing empirical mode decomposition on the density signals to obtain a plurality of intrinsic mode functions according to different density fluctuation frequencies;
step 35: performing a Hilbert transform on each intrinsic mode function to obtain an analytical signal for each intrinsic mode function, and integrating the analytical signals of all intrinsic mode functions to obtain Hilbert spectrums of particles in the bed layer.

Compared with the prior art, the present disclosure achieves at least the following beneficial effects:

In the dynamic fluidized bed system provided by the present disclosure, a pressure acquisition unit is arranged in the bed layer of the fluidization chamber, which acquires pressure signals at different vertical positions within the bed layer and generates Hilbert spectrums of particles in the bed layer based on the pressure signals. The Hilbert spectrums are used to determine whether the bed layer is in a mixed state or a separated state. This allows understanding the state of the bed layer before formal separation, and adjusting various parameters to bring the bed layer to a mixed state, thereby better guiding subsequent formal separation and improving the separation effect.

In the present disclosure, the above technical solutions can also be combined with each other to achieve more preferred combinations. Other features and advantages of the present disclosure will be described in the following description, and in part, the advantages will become apparent from the description, or be learned by practicing the disclosure. The purpose and other advantages of the disclosure can be realized and obtained from the contents specifically pointed out in the description, embodiments, and drawings.

### BRIEF DESCRIPTION OF THE DRAWINGS

The drawings are only used to illustrate the purpose of specific embodiments and are not considered as limitations of the present disclosure. Throughout the drawings, the same reference symbols denote the same components.

FIG. 1 is a schematic structural diagram of the dynamic fluidized bed system provided by the present disclosure;

FIG. 2 is a schematic structural diagram of an air distribution chamber in the dynamic fluidized bed system provided by the present disclosure;

FIG. 3 is a schematic structural diagram of an air distribution plate in the dynamic fluidized bed system provided by the present disclosure;

FIG. 4A is a schematic diagram of EMD decomposition of the upper part of the bed layer in Example 1;

FIG. 4B is a schematic diagram of EMD decomposition of the middle part of the bed layer in Example 1;

FIG. 4C is a schematic diagram of EMD decomposition of the lower part of the bed layer in Example 1;

FIG. 5A is a Hilbert spectrum of the upper part of the bed layer in Example 1;

FIG. 5B is a Hilbert spectrum of the middle part of the bed layer in Example 1;

FIG. 5C is a Hilbert spectrum of the lower part of the bed layer in Example 1;

FIG. 6A is a schematic diagram of EMD decomposition of the upper part of the bed layer in Example 2;

FIG. 6B is a schematic diagram of EMD decomposition of the middle part of the bed layer in Example 2;

FIG. 6C is a schematic diagram of EMD decomposition of the lower part of the bed layer in Example 2;

FIG. 7A is a Hilbert spectrum of the upper part of the bed layer in Example 2;

FIG. 7B is a Hilbert spectrum of the middle part of the bed layer in Example 2;

FIG. 7C is a Hilbert spectrum of the lower part of the bed layer in Example 2.

### REFERENCE NUMERALS

1—blower; 2—air reservoir; 3—flow meter; 4—flow regulating valve; 5—vibrating table; 6—fluidization chamber; 7—air distribution chamber; 701—inner telescopic sealing ring; 702—outer telescopic sealing ring; 703—inner pipe; 704—outer pipe; 705—suction pump; 8—air distribution plate; 9—air distribution layer; 10—pipe; 11—pressure sensor; 12—controller; 13—gangue discharge port.

### DETAILED DESCRIPTION OF THE EMBODIMENTS

The preferred embodiments of the present disclosure are described in detail below with reference to the accompanying drawings, which constitute a part of the present disclosure and are used together with the embodiments of the present disclosure to explain the principles of the present disclosure, and are not intended to limit the scope of the present disclosure.

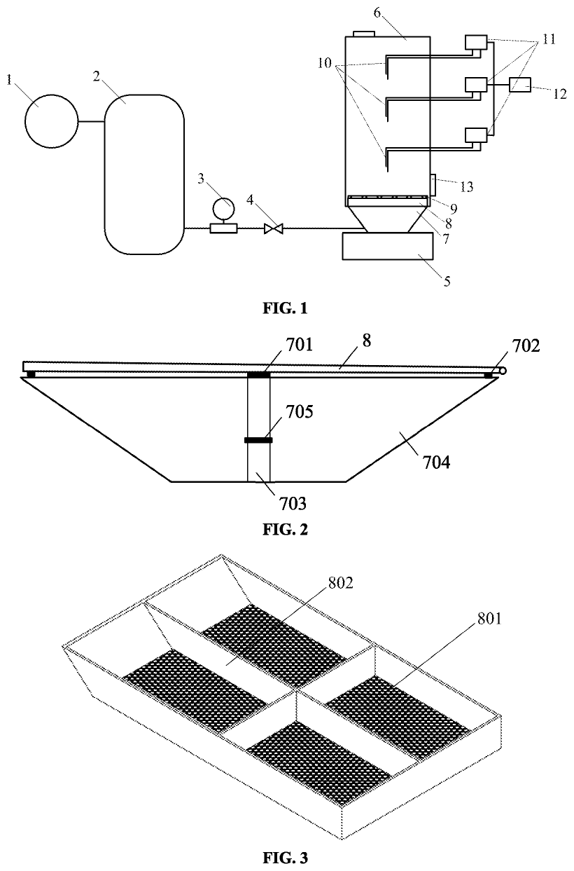

In a first aspect, the present disclosure provides a dynamic fluidized bed system. Referring to FIG. 1, it includes a blower 1, an air reservoir 2, a vibrating table 5, a fluidization chamber 6, a pressure acquisition unit, and a controller 12. The fluidization chamber 6 is placed on the vibrating table 5, which drives the fluidization chamber 6 to perform periodic sinusoidal vertical vibration with a vibration frequency of 0 to 50 Hz and an amplitude of 1 to 5 mm. The air outlet of the blower 1 is connected to the inner cavity of the fluidization chamber 6 via the air reservoir 2, supplying airflow into the inner cavity of the fluidization chamber 6. The airflow and vibration work together to fluidize the particles within the fluidization chamber 6. The fluidization chamber 6 has a raw coal inlet and a gangue discharge port 13. The raw coal inlet is located on one side of the top of the fluidization chamber 6, and the gangue discharge port 13 is located on one side of the bottom of the fluidization chamber 6. The data acquisition ends of the pressure acquisition unit are located in the bed layer of the fluidization chamber 6. The pressure acquisition unit acquires pressure signals at different vertical positions within the bed layer and transmits them to a controller 12. The controller 12 receives the pressure signals, calculates differential pressure signals, converts the differential pressure signals into density signals, processes the density signals to generate Hilbert spectrums of particles in the bed layer, and determines whether the bed layer is in a mixed state or a separated state based on the Hilbert spectrums.

The specific determination method is as follows:

The X-axis coordinate of the Hilbert spectrum is frequency, the Y-axis coordinate is time, and the Z-axis coordinate is density fluctuation amplitude. For a vibrated fluidized bed, 0~10 Hz is the bubble frequency, and 20~30 Hz is the vibration frequency. If the peak density fluctuation amplitude at 0~10 Hz is less than or equal to the peak density fluctuation amplitude at 20~30 Hz, it indicates that the bed layer is in a separated state; if the peak density fluctuation amplitude at 0~10 Hz is greater than the peak density fluctuation amplitude at 20~30 Hz, it indicates that the fluidized bed is in a mixed state.

Specifically, the pressure acquisition unit comprises an upper pressure acquisition assembly, a middle pressure acquisition assembly, and a lower pressure acquisition assembly arranged sequentially from top to bottom. The upper pressure acquisition assembly is used to acquire two pressure signals at different vertical positions in the upper part of the bed layer, the middle pressure acquisition assembly is used to acquire two pressure signals at different vertical positions in the middle part of the bed layer, and the lower pressure acquisition assembly is used to acquire two pressure signals at different vertical positions in the lower part of the bed layer. The difference between the two pressure signals is the differential pressure signal.

Compared with the prior art, in the dynamic fluidized bed system provided by the present disclosure, a pressure acquisition unit is arranged in the bed layer of the fluidization chamber 6, which acquires pressure signals at different vertical positions within the bed layer and generates Hilbert spectrums of particles in the bed layer based on the pressure signals. The Hilbert spectrums are used to determine whether the bed layer is in a mixed state or a separated state. This allows understanding the state of the bed layer before formal separation, and adjusting various parameters to bring the bed layer to a mixed state, thereby better guiding subsequent formal separation and improving the separation effect.

It should be noted that during operation, raw coal enters the fluidization chamber 6 from the raw coal inlet, and airflow is supplied into the fluidization chamber 6; within the fluidization chamber 6, the raw coal is subjected to a combined force field of excitation force and airflow, causing stratification in the longitudinal direction within the fluidization chamber 6 based on density differences. Light-density coarse cleaned coal stays in the upper part of the fluidization chamber 6, high-density gangue particles settle to the lower part of the fluidization chamber 6, and medium-density materials (including a mixture of middlings and cleaned coal for re-separation) are suspended in the middle of the fluidization chamber 6, thereby achieving the separation of raw coal.

To regulate the gas flow rate supplied into the fluidization chamber 6, the dynamic fluidized bed system further comprises a flow regulating valve 4 arranged on the connecting pipeline between the air reservoir 2 and the fluidization chamber 6. The gas flow rate supplied into the fluidization chamber 6 is regulated by the flow regulating valve 4.

To enable real-time detection of the gas flow rate supplied into the fluidization chamber 6, the dynamic fluidized bed system further comprises a flow meter 3 arranged on the connecting pipeline between the air reservoir 2 and the fluidization chamber 6. The flow meter 3 detects the gas flow rate supplied from the air reservoir 2 into the fluidization chamber 6 in real time.

To achieve stable connections between various components, connections between the blower 1 and the air reservoir 2, between the air reservoir 2 and the flow meter 3, between the flow meter 3 and the flow regulating valve 4, and between the flow regulating valve 4 and the fluidization chamber 6 are all through pipelines. Exemplarily, the pipelines between the blower 1 and the air reservoir 2, between the air reservoir 2 and the flow meter 3, and between the flow meter 3 and the flow regulating valve 4 are rigid pipelines, while the pipeline between the flow regulating valve 4 and the fluidization chamber 6 is a flexible pipeline to accommodate the vibration of the fluidization chamber 6.

To ensure the processing capacity of the fluidization chamber 6, exemplarily, the inner diameter of the fluidization chamber 6 is 350~450 mm (e.g., 400 mm), and the height of the fluidization chamber 6 is 450~550 mm (e.g., 500 mm).

To ensure the stability of the airflow supplied into the fluidization chamber 6, the above dynamic fluidized bed system further comprises an air distribution chamber 7, an air distribution plate 8, and an air distribution layer 9. The air distribution chamber 7 is located at the bottom of the fluidization chamber 6 and is connected to it, with the two being detachably connected by bolts. The bottom end of the air distribution chamber 7 is detachably connected to the vibrating table 5 by bolts. The air distribution plate 8 and the air distribution layer 9 are arranged between the air distribution chamber 7 and the fluidization chamber 6. The air inlet of the air distribution chamber 7 is connected to the air outlet of the air reservoir 2. Thus, the arrangement of the air distribution chamber 7, the air distribution plate 8, and the air distribution layer 9 ensures the stability of the airflow supplied into the fluidization chamber 6, thereby enabling the generation of a stable bed layer.

Exemplarily, the air distribution plate 8 is a porous steel plate with a thickness of 2.5~4 mm (e.g., 3 mm), a pore diameter of 2.5~3.5 mm (e.g., 3 mm), and a center-to-center distance between adjacent pores of 4.5~5.0 mm (e.g., 4.8 mm). The opening ratio of the air distribution plate 8 is 25~35% (e.g., 30%).

To ensure a sealed connection between the air distribution chamber 7 and the fluidization chamber 6, an elastic sealing gasket (e.g., a rubber gasket) is provided between them.

To ensure the accuracy of pressure acquisition while reducing the impact of the pressure acquisition unit on the bed layer, the upper pressure acquisition assembly, the middle pressure acquisition assembly, and the lower pressure acquisition assembly have substantially the same structure, each comprising two pipes 10 (e.g., copper pipes) and one pressure sensor 11. The two pipes 10 are detachably and fixedly connected. The pressure sensor 11 has two data input ports. The pipes 10 correspond one-to-one with the data input ports and are connected to them via connecting tubes (e.g., rubber hoses). The pipes 10 are inserted into the bed layer, and the two pipes 10 are located at different vertical positions within the bed layer.

Exemplarily, the height difference between the two pipes 10 is 1.5~2.5 cm (e.g., 2 cm), and the inner diameter of the pipes 10 is 3~5 mm (e.g., 4 mm).

To prevent particles within the bed layer from entering the pipes 10 and causing blockage, the upper pressure acquisition assembly, the middle pressure acquisition assembly, and the lower pressure acquisition assembly further comprise filter layers. The filter layers are sleeved on the air inlets of the pipes 10 to filter particles from the bed layer.

In a second aspect, the present disclosure provides another dynamic fluidized bed system, which is substantially the same in structure as the dynamic fluidized bed system provided in Embodiment 1, with the difference being:
Considering that gangue particles move along the air distribution plate 8 to the gangue discharge port 13 for discharge, to adjust the discharge rate of gangue particles, exemplarily, one end of the air distribution plate 8 near the gangue discharge port 13 is rotatably connected to the fluidization chamber 6, and the other end of the air distribution plate 8 is a free end. By rotating the air distribution plate 8, its inclination angle is adjusted, thereby achieving adjustment of the gangue particle discharge rate.

To adjust the inclination angle of the air distribution plate 8 using airflow, regarding the structure of the air distribution chamber 7, specifically, referring to FIG. 2, the air distribution chamber 7 includes an inner telescopic sealing ring 701, an outer telescopic sealing ring 702, an inner pipe 703, and an outer pipe 704 sleeved outside the inner pipe 703. There is a gap between the outer pipe 704 and the inner pipe 703. The air distribution plate 8 is divided into a central area and a surrounding area around the central area. The surrounding area is provided with main air distribution holes, while the central area is not provided with main air distribution holes. The air outlet of the inner pipe 703 covers the central area and is connected to the edge of the central area via the inner telescopic sealing ring 701. The inner pipe 703 is equipped with a suction pump 705. The air outlet of the outer pipe 704 covers the surrounding area and is connected to the edge of the surrounding area via the outer telescopic sealing ring 702.

When there is no need to increase the inclination angle of the air distribution plate 8, only the outer pipe 704 supplies air into the fluidization chamber 6 through the main air distribution holes; when the inclination angle of the air distribution plate 8 needs to be increased, the suction pump 705 is activated, and airflow is supplied into both the inner pipe 703 and the outer pipe 704, causing the lengths of the inner telescopic sealing ring 701 and the outer telescopic sealing ring 702 to increase, the air distribution plate 8 rotates clockwise, and its inclination angle increases. In this way, through the cooperating inner pipe 703 and outer pipe 704, the pressure of the airflow can drive the rotation of the air distribution plate 8, thereby achieving adjustment of the inclination angle of the air distribution plate 8 using airflow without the need for additional separate driving mechanisms for the air distribution plate 8.

In a third aspect, the present disclosure provides a third dynamic fluidized bed system, which is substantially the same in structure as the dynamic fluidized bed system provided in Embodiment 1, with the difference being:
Regarding the structure of the air distribution plate 8, referring to FIG. 3, it includes a distribution groove and partition ribs 802. The partition ribs 802 are arranged in the distribution groove, dividing the distribution groove into multiple sub-distribution grooves 801. The bottom of each sub-distribution groove 801 is provided with air inlet holes. The air distribution layer 9 covers the opening of the distribution groove.

In a fourth aspect, the present disclosure provides a dynamic fluidized separation method, using the dynamic fluidized bed system provided in the first, second, or third aspect. The separation method comprises the following steps:
step 1: setting a sampling frequency and sampling time of the pressure acquisition unit, selecting a vibration frequency, a vibration amplitude, a gas supply flow rate, and a coal sample flow rate;
step 2: starting the vibrating table and the blower, feeding coal samples into the fluidization chamber, where the coal samples are samples of raw coal;
step 3: the pressure acquisition unit acquiring pressure signals at different vertical positions within the bed layer and transmitting the pressure signals to the controller, the controller receiving the pressure signals, calculating differential pressure signals, converting the differential pressure signals into density signals, and processing the density signals to generate Hilbert spectrums of particles in the bed layer;
step 4: determining whether the bed layer is in a mixed state or a separated state based on the Hilbert spectrums;
in case the bed layer is in the mixed state, proceed to step 5;
in case the bed layer is in the separated state, increase the vibration frequency, vibration amplitude, and/or gas supply flow rate, and/or decrease the coal sample flow rate, and repeat step 3;
step 5: feeding raw coal into the fluidization chamber, and separating the raw coal according to the selected vibration frequency, vibration amplitude, gas supply flow rate, and coal sample flow rate.

Compared with the prior art, the beneficial effects of the dynamic fluidized separation method provided by the present disclosure are substantially the same as those of the dynamic fluidized bed system provided in the first, second, or third aspect, and are not repeated here.

Specifically, step 3 comprises the following steps:
step 31: the pressure acquisition unit respectively acquiring two sets of pressure signals from the upper part, two sets of pressure signals from the middle part, and two sets of pressure signals from the lower part of the bed layer, and transmitting them to the controller;
step 32: the controller receiving the pressure signals and calculating a differential pressure signal for the upper part of the bed layer, a differential pressure signal for the middle part of the bed layer, and a differential pressure signal for the lower part of the bed layer;
step 33: converting the differential pressure signals into density signals using a conversion formula, the conversion formula being formed after calibration of the pressure sensor, the conversion formula is as follows:

$$ρ = \frac{Δ P}{gh}$$

where:
ρ is the bed density, g/cm³;
ΔP is the differential pressure signal, Pa;
g is the gravitational coefficient, N/kg;
h is the height difference of the pipes, mm.
Step 34: defining the set of all ρ as the density signals x(t), performing Empirical Mode Decomposition (EMD) on the density signals x(t) to obtain a plurality of Intrinsic Mode Functions (IMFs) and a residual signal that can characterize the overall trend of density change according to different density fluctuation frequencies, where each intrinsic mode function represents the density fluctuation frequency of the density signals x(t) at different time scales, obtaining an EMD decomposition diagram (including separated state and/or mixed state) of particles in the dynamic fluidized bed system;
Step 35: performing a Hilbert transform on each intrinsic mode function to obtain an analytical signal for each intrinsic mode function, where the analytical signal includes the frequency, amplitude, phase, and time of the density signals, and integrating the analytical signals of all intrinsic mode functions to obtain Hilbert spectrums (including separated state and/or mixed state) of particles in the dynamic fluidized bed system.

In practical applications, empirical mode decomposition and Hilbert transform can be implemented based on the MATLAB platform, and are not described in detail here.

Specifically, in the above step 4, the method for determining whether the bed layer is in a mixed state or a separated state based on the Hilbert spectrums is as follows:
if the peak density fluctuation amplitudes at 0~10 Hz are less than or equal to the peak density fluctuation amplitudes at 20~30 Hz, it indicates that the bed layer is in a separated state;
if the peak density fluctuation amplitudes at 0~10 Hz are greater than the peak density fluctuation amplitudes at 20~30 Hz, it indicates that the fluidized bed is in a mixed state.

### Example 1

This example provides a dynamic fluidized separation method. The specific method refers to the fourth aspect. The parameters are as follows:

The number of pressure sensors is three, each pressure sensor corresponds to two copper pipes, the two copper pipes are bound as one group, and the three groups of copper pipes are inserted into the upper, middle, and bottom parts of the fluidized bed layer respectively. The sampling frequency of the pressure sensors is 200 Hz, the sampling time is 20 s, and the pressure signals from the 10th to 15th seconds are intercepted during analysis.

The vibration frequency f of the vibrating table is 25 Hz, the vibration amplitude A of the vibrating table is 1 mm, the inlet gas flow rate U_{g} of the fluidization chamber is 1.0 U_{mfv}, and the coal sample flow rate is 0.3 kg/s.

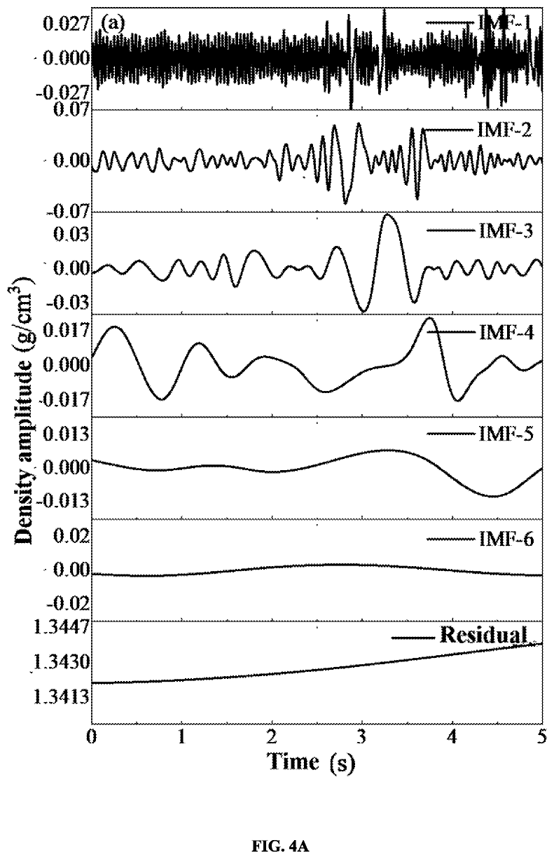

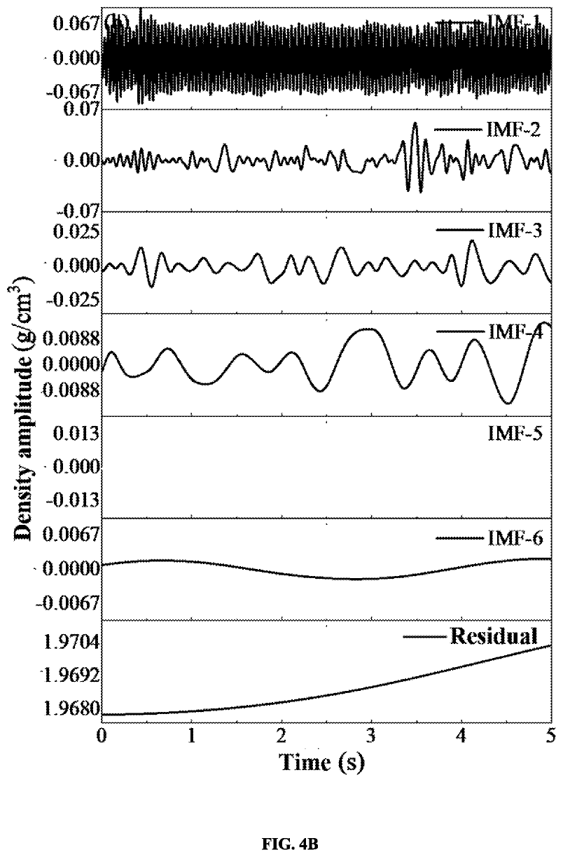

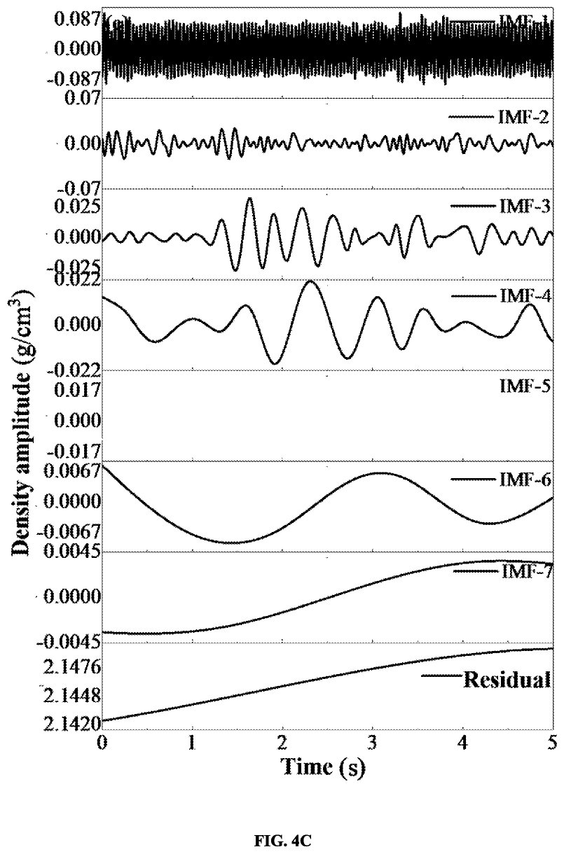

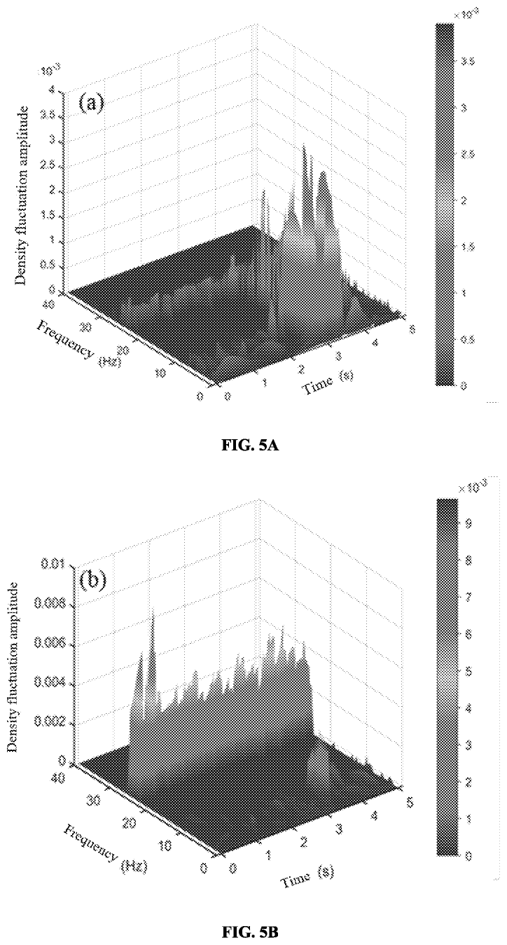

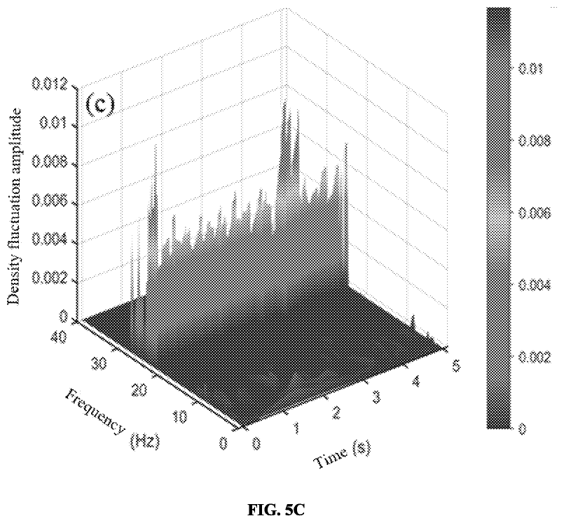

The obtained intrinsic mode functions are shown in FIGS. 4A to 4C (IMF-1, IMF-2, IMF-3, IMF-4, IMF-5, and IMF-6), and the Hilbert spectrums are shown in FIGS. 5A to 5C. It can be seen from FIGS. 4A to 4C that the fluctuation pattern and amplitude of IMF-1 are significantly different in the upper, middle, and lower parts. As the bed depth increases, the fluctuation of IMF-1 becomes more regular and the amplitude becomes larger.

It can be seen from FIGS. 5A to 5C that there is a relatively obvious density fluctuation amplitude at 0-10 Hz in the upper part, while the density fluctuation amplitude at 20-30 Hz is weak. There is a relatively obvious density fluctuation amplitude at 25 Hz in the middle and bottom parts, indicating that the bed layer is in a separated state, and the density fluctuation amplitude and distribution pattern differ significantly across different regions of the bed layer.

### Example 2

This example provides a dynamic fluidized separation method. The specific method refers to the fourth aspect. The parameters are as follows:

The number of pressure sensors is three, each pressure sensor corresponds to two copper pipes, the two copper pipes are bound as one group, and the three groups of copper pipes are inserted into the upper, middle, and bottom parts of the fluidized bed layer respectively. The sampling frequency of the pressure sensors is 200 Hz, the sampling time is 20 s, and the pressure signals from the 10th to 15th seconds are intercepted during analysis.

The vibration frequency f of the vibrating table is 25 Hz, the vibration amplitude A of the vibrating table is 2 mm, the inlet gas flow rate U_{g} of the fluidization chamber is 1.4 U_{mfv}, and the coal sample flow rate is 0.25 kg/s.

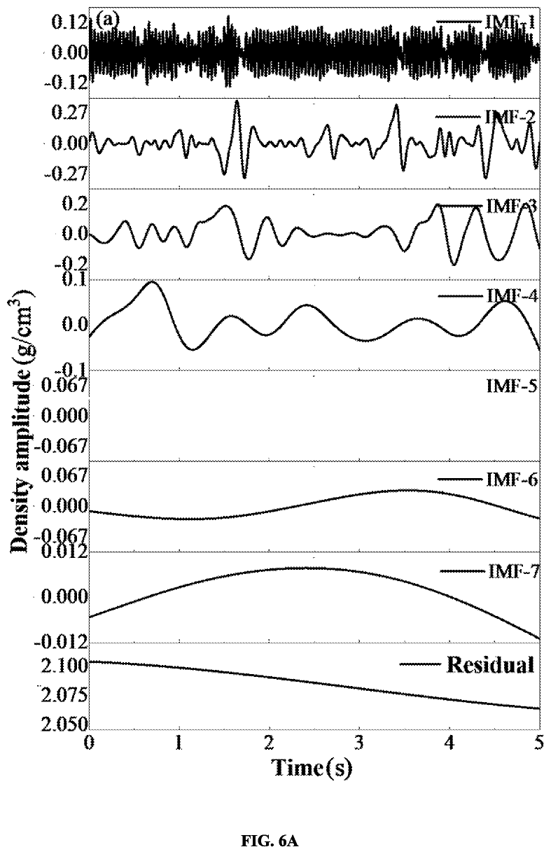

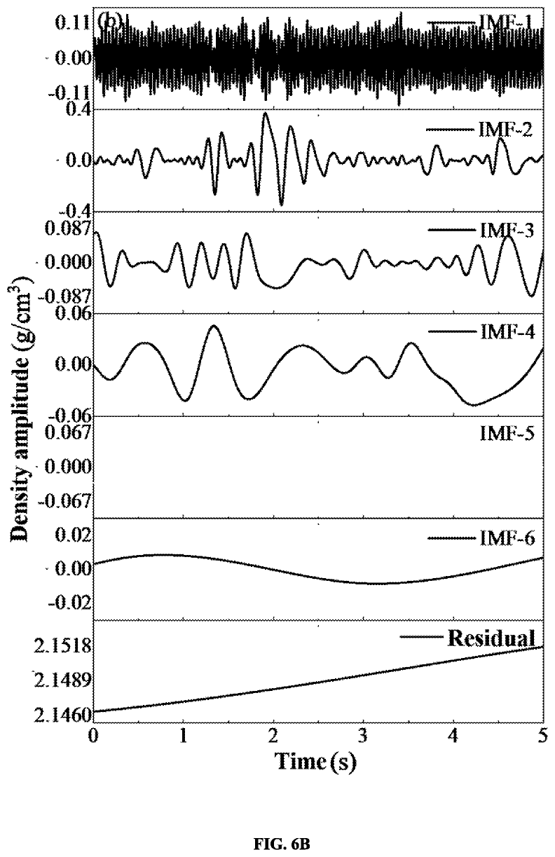

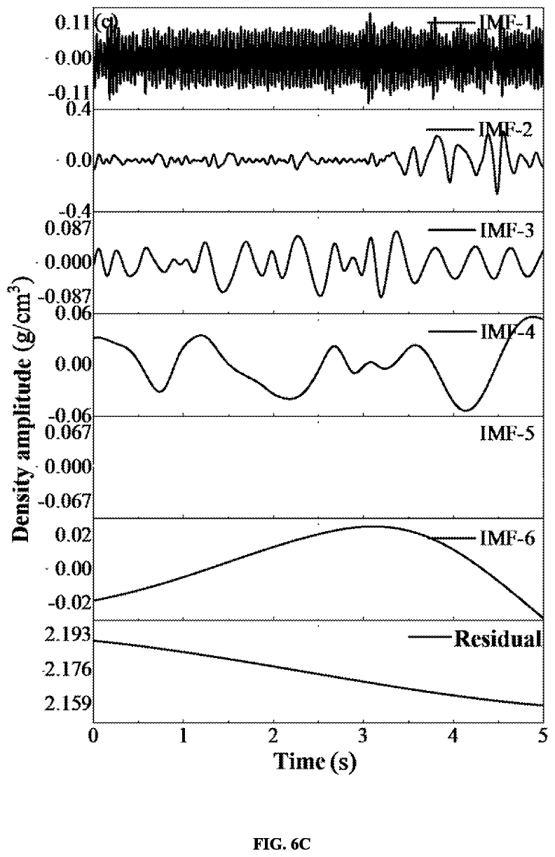

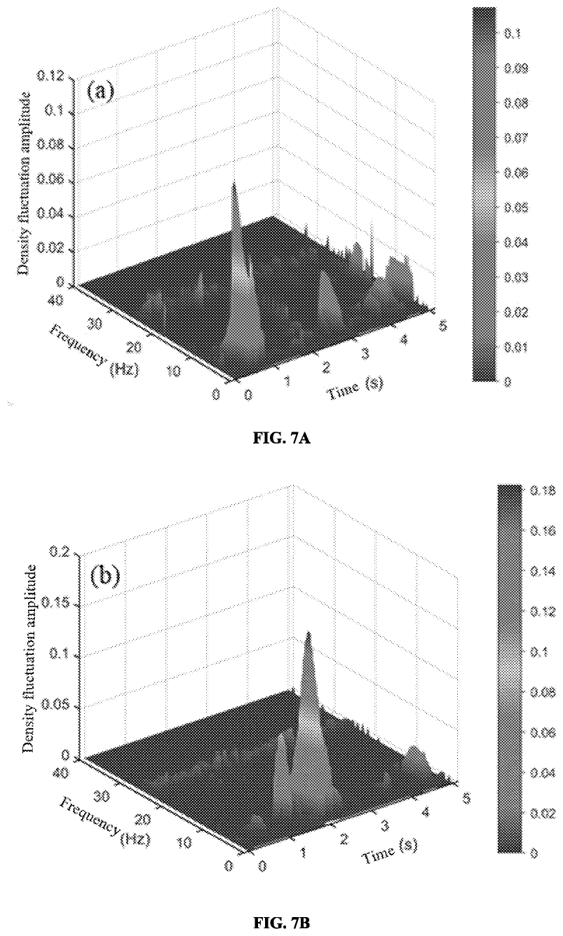

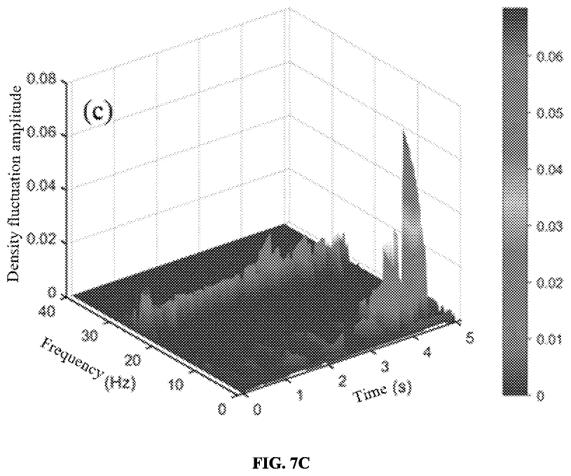

The obtained intrinsic mode functions are shown in FIGS. 6A to 6C, and the Hilbert spectrums are shown in FIGS. 7A to 7C. It can be seen from FIGS. 6A to 6C that the oscillation mode, amplitude pattern, and variation trend of IMF-1 tend to be consistent in the upper, middle, and lower parts.

It can be seen from FIGS. 7A to 7C that there is a relatively obvious density fluctuation amplitude at 0-10 Hz in the upper, middle, and lower parts, while the density fluctuation amplitude at 25 Hz is not obvious, indicating that the bed layer is in a mixed state, and the density fluctuation amplitude and distribution pattern do not differ significantly across different regions of the bed layer.

The above description is only for preferred specific embodiments of the present disclosure, but the scope of protection of the present disclosure is not limited thereto. Any changes or substitutions that can be easily conceived by a person skilled in the art within the technical scope disclosed by the present disclosure shall be covered within the scope of protection of the present disclosure.

What is claimed is:

1. A dynamic fluidized bed system, comprising a blower, a vibrating table, a fluidization chamber, a pressure acquisition unit and a controller;
the fluidization chamber is placed on the vibrating table, the vibrating table drives the fluidization chamber to vibrate, and an air outlet of the blower is connected to an inner cavity of the fluidization chamber;
data acquisition ends of the pressure acquisition unit are located in a bed layer of the fluidization chamber, the pressure acquisition unit acquires pressure signals at different vertical positions within the bed layer and transmits the pressure signals to the controller, the controller receives the pressure signals, calculates differential pressure signals, converts the differential pressure signals into density signals, processes the density signals to generate Hilbert spectrums of particles in the bed layer, and determines whether the bed layer is in a mixed state or a separated state based on the Hilbert spectrums; an X-axis coordinate of the Hilbert spectrums is frequency, a Y-axis coordinate is time, and a Z-axis coordinate is density fluctuation amplitude; 0~10 Hz is a bubble frequency, and 20~30 Hz is a vibration frequency; in case peak density fluctuation amplitude at 0~10 Hz is less than or equal to peak density fluctuation amplitude at 20~30 Hz, indicating that the bed layer is in the separated state; in case the peak density fluctuation amplitude at 0~10 Hz is greater than the peak density fluctuation amplitude at 20~30 Hz, indicating that the fluidized bed is in the mixed state;
wherein the dynamic fluidized bed system further comprises an air distribution chamber, an air distribution plate, and an air distribution layer, the air distribution chamber is located at a bottom of the fluidization chamber and is connected to the fluidization chamber, a bottom end of the air distribution chamber is connected to the vibrating table, the air distribution plate and the air distribution layer are arranged between the air distribution chamber and the fluidization chamber, and an air inlet of the air distribution chamber is connected to the air outlet of the blower;
one end of the air distribution plate near a gangue discharge port is rotatably connected to the fluidization chamber, and an other end of the air distribution plate is a free end; the air distribution chamber comprises an inner telescopic sealing ring, an outer telescopic sealing ring, an inner pipe, and an outer pipe sleeved outside the inner pipe; a gap is between the outer pipe and the inner pipe; the air distribution plate is divided into a central area and a surrounding area around the central area; the surrounding area is provided with main air distribution holes, while the central area is not provided with main air distribution holes; an air outlet of the inner pipe covers the central area and is connected to an edge of the central area via the inner telescopic sealing ring; the inner pipe is equipped with a suction pump; an air outlet of the outer pipe covers the surrounding area and is connected to an edge of the surrounding area via the outer telescopic sealing ring.

2. The dynamic fluidized bed system according to claim 1, wherein the pressure acquisition unit comprises an upper pressure acquisition assembly, a middle pressure acquisition assembly, and a lower pressure acquisition assembly arranged sequentially from top to bottom, the upper pressure acquisition assembly is used to acquire two pressure signals at different vertical positions in an upper part of the bed layer, the middle pressure acquisition assembly is used to acquire two pressure signals at different vertical positions in a middle part of the bed layer, and the lower pressure acquisition assembly is used to acquire two pressure signals at different vertical positions in a lower part of the bed layer.

3. The dynamic fluidized bed system according to claim 2, wherein the upper pressure acquisition assembly, the middle pressure acquisition assembly, and the lower pressure acquisition assembly each comprise two pipes and one pressure sensor, the two pipes are detachably and fixedly connected, the pressure sensor has two data input ports, pipes correspond one-to-one with the data input ports, the pipes are connected to the data input ports, the pipes are inserted into the bed layer, and the two pipes are located at different vertical positions within the bed layer.

4. The dynamic fluidized bed system according to claim 3, wherein a height difference between the two pipes is 1.5 to 2.5 cm, and an inner diameter of the pipes is 3 to 5 mm.

5. The dynamic fluidized bed system according to claim 3, wherein the upper pressure acquisition assembly, the middle pressure acquisition assembly, and the lower pressure acquisition assembly each further comprises filter layers, and the filter layers are sleeved on air inlets of the pipes.

6. The dynamic fluidized bed system according to claim 1, wherein the dynamic fluidized bed system further comprises a flow regulating valve arranged on a connecting pipeline between an air reservoir and the fluidization chamber.

7. The dynamic fluidized bed system according to claim 1, wherein the dynamic fluidized bed system further comprises a flow meter arranged on the connecting pipeline between the air reservoir and the fluidization chamber.

8. A dynamic fluidized separation method, using the dynamic fluidized bed system according to claim 1, the separation method comprising the following steps:
step 1: setting a sampling frequency and sampling time of the pressure acquisition unit, selecting a vibration frequency, a vibration amplitude, a gas supply flow rate, and a coal sample flow rate;
step 2: starting the vibrating table and the blower, feeding coal samples into the fluidization chamber, wherein the coal samples are samples of raw coal;
step 3: the pressure acquisition unit acquiring pressure signals at different vertical positions within the bed layer and transmitting the pressure signals to the controller, the controller receiving the pressure signals, calculating differential pressure signals, converting the differential pressure signals into density signals, and processing the density signals to generate Hilbert spectrums of particles in the bed layer;
step 4: determining whether the bed layer is in the mixed state or the separated state based on the Hilbert spectrum;
in case the bed layer is in the mixed state, proceed to step 5;
in case the bed layer is in the separated state, increase the vibration frequency, the vibration amplitude, and/or the gas supply flow rate, and/or decrease the coal sample flow rate, and repeat step 3;
step 5: feeding raw coal into the fluidization chamber, and separating the raw coal according to selected vibration frequency, vibration amplitude, gas supply flow rate, and coal sample flow rate.

9. The dynamic fluidized separation method according to claim 8, wherein step 3 comprises the following steps:
step 31: the pressure acquisition unit respectively acquiring two sets of pressure signals from the upper part, two sets of pressure signals from the middle part, and two sets of pressure signals from the lower part of the bed layer, and transmitting them to the controller;
step 32: the controller receiving the pressure signals and calculating a differential pressure signal for the upper part of the bed layer, a differential pressure signal for the middle part of the bed layer, and a differential pressure signal for the lower part of the bed layer;
step 33: converting differential pressure signals into density signals using a conversion formula, wherein the conversion formula is formed after calibration of pressure sensors, the conversion formula is as follows:
$$ρ = \frac{Δ P}{gh}$$
wherein:
ρ is a bed density, g/cm³;
g is a gravitational coefficient, N/kg;
h is a height difference of the pipes, mm;
step 34: defining a set of all ρ as the density signals, performing empirical mode decomposition on the density signals to obtain a plurality of intrinsic mode functions according to different density fluctuation frequencies;
step 35: performing a Hilbert transform on each intrinsic mode function to obtain an analytical signal for each intrinsic mode function, and integrating analytical signals of all intrinsic mode functions to obtain the Hilbert spectrums of particles in the bed layer.
